(19) United States
(12) Patent Application Publication
(10) Pub. No.: US 2014/0071042 A1
(43) Pub. Date: Mar. 13, 2014

(54) COMPUTER VISION BASED CONTROL OF A DEVICE USING MACHINE LEARNING

(71) Applicant: Eran Eilat, Givatayim (IL)

(72) Inventor: Eran Eilat, Givatayim (IL)

(73) Assignee: POINTGRAB LTD., Hod Hasharon (IL)

(21) Appl. No.: 13/984,853

(22) PCT Filed: May 31, 2012
(86) PCT No.: PCT/IL12/50191

§ 371 Date: Aug. 12, 2013

Related U.S. Application Data
(60) Provisional application No. 61/491,334, filed on May 31, 2011.

(51) Int. Cl. G06F 3/01

(52) U.S. Cl. CPC G06F 3/017
USPC 345/156

(57) ABSTRACT

A method for computer vision based control of a device, the method comprising: obtaining a first frame comprising an image of an object within a field of view; identifying the object as a hand by applying computer vision algorithms; storing image related information of the identified hand; obtaining a second frame comprising an image of an object within a field of view and identifying the object in the second frame as a hand by using the stored information of the identified hand; and controlling the device based on the hand identified in the first and second frames.

### FIELD OF THE INVENTION

The present invention relates to the field of computer vision based control of electronic devices. Specifically, the invention relates to computer vision based hand identification using machine learning techniques.

### BACKGROUND OF THE INVENTION

The need for more convenient, intuitive and portable input devices increases, as computers and other electronic devices become more prevalent in our everyday life.

Recently, human gesturing, such as hand gesturing, has been suggested as a user interface input tool in which a hand gesture is detected by a camera and is translated into a specific command. Gesture recognition enables humans to interface with machines naturally without any mechanical appliances. The development of alternative computer interfaces (forgoing the traditional keyboard and mouse), video games and remote controlling are only some of the fields that may implement human gesturing techniques.

Recognition of a hand gesture usually requires identification of an object as a hand and tracking the identified hand to detect a posture or gesture that is being performed.

Known gesture recognizing systems detect a user hand by using color, shape and/or contour detectors.

Machine learning techniques can be used to train a machine to discriminate between features and thus to identify objects, typically different faces or facial expressions. Machines can be trained to identify objects belonging to a specific group (such as human faces) by providing the machine with many training examples of objects belonging to the specific group. Thus, during manufacture a machine is supplied with abroad pre-made database with which to compare any new object that is later presented to the machine during use, after the machine has left the manufacturing facility.

However, identifying a human hand in the process of gesturing may prove to be a challenge for these methods of detection because many environments include designs that may be similar enough to a human hand to cause too many cases of false identification and the variety of possible backgrounds make it impossible to include all background options in a pre-made database.

### SUMMARY OF THE INVENTION

The method for computer vision based control of a device, according to embodiments of the invention, provides an efficient process for accurate hand identification, regardless of the background environment and of other complications such as the hand's posture or angle at which it is being viewed.

The method according to embodiments of the invention facilitates hand identification so that in the process of tracking the hand, even if sight of the hand is lost (hand changes orientation or position, hand moves by confusing background, etc.), re-identifying the hand is quick, thereby enabling better tracking of the hand.

According to embodiments of the invention image related information is stored on-line, during use, rather than using pre-made databases. This enables each machine to learn its specific environment and user enabling more accurate and quick identification of the user's hand.

According to one embodiment of the invention there is provided a method for computer vision based control of a device, the method including the steps of obtaining a first frame comprising an image of an object within a field of view; identifying the object as a hand by applying computer vision algorithms; storing image related information of the identified hand; obtaining a second frame comprising an image of an object within a field of view and identifying the object in the second frame as a hand by using the stored information of the identified hand; and controlling the device based on the hand identified in the first and second frames.

This process may continue by storing image related information of the hand identified in the second frame. According to some embodiments an on-line database may thus be constructed.

Image related information may include Local Binary Pattern (LBP) features, statistical parameters of grey level or Speeded Up Robust Features (SURF) or other appropriate features.

The method may include tracking the hand identified in the first frame and continuing the tracking only if the hand is also identified in the second image. The device may be controlled according to the tracking of the hand.

The method may further include identifying a non-hand object and storing image related information of the non-hand object. According to some embodiments the image related information of the object identified as a hand and the image related information of the non-hand object are stored only if the information is different than any image related information already stored.

According to some embodiments the image related information of an object identified as a hand and/or the image related information of the non-hand object is stored for a pre-defined period. The pre-defined period may be based on use or on absolute time.

A non-hand object may be a portion of a frame, said portion not including a hand. The portion may be located at a pre-determined distance or further from the position of the hand within the frame. According to some embodiments the portion includes an area in which no movement was detected.

According to some embodiments identifying the object in the second frame as a hand by using the information of the identified hand includes detecting in the identified hand a set of features; assigning a value to each feature; and comparing the values of the features to a hand identification threshold, said hand identification threshold constructed by using values of features of formerly identified hands. A new hand identification threshold may be constructed every pre-defined period.

According to some embodiments the object in the first image is identified as a hand only if the object is moving in a pre-defined movement, such as a wave like movement.

The object identified as a hand may be a hand in any posture or post-posture. Thus, the method may include storing image related shape information of the hand in a predefined posture; and obtaining a second frame comprising an image of an object within a field of view and identifying the object in the second frame as a hand in the predefined posture by using the stored shape information.

A posture may be, for example, a hand with all fingers extended or a hand with all fingers brought together such that their tips are touching or almost touching. Post-posture may be, for example, a hand during the act of extending fingers after having held them in a first or closed fingers posture.

The device may be controlled according to a posture or gesture of the hand.

According to another embodiment of the invention there is provided a system for computer vision based control of a device, the system comprising: an adaptive detector, said detector configured to identify an object in a first image as a hand; store image related information of the identified hand; and identify an object in a second image as a hand by using the stored image related information; a processor to track the identified hand; and a controller to control the device based on the identified hand.

The system may further include an image sensor to obtain the first and second images, said image sensor in communication with the adaptive detector. The sensor may be a 2D camera.

The system may also include a processor to identify a hand gesture or posture and the controller generates a user command based on the identified hand gesture or posture.

The device may be a TV, DVD player, PC, mobile phone, camera, STB (Set Top Box) and a streamer.

### BRIEF DESCRIPTION OF THE FIGURES

The invention will now be described in relation to certain examples and embodiments with reference to the following illustrative figures so that it may be more fully understood. In the drawings:

FIGS. 1A-C schematically illustrate methods for computer vision based control of a device according to embodiments of the invention;

FIG. 2A schematically illustrates a method for computer vision based control of a device including re-setting a database of hand objects, according to an embodiment of the invention;

FIG. 2B schematically illustrates a method for machine learning identification of a hand including re-setting a hand identification threshold, according to an embodiment of the invention;

FIGS. 3A-3E schematically illustrate a method for training a hand identification system on-line, according to an embodiment of the invention;

FIG. 4 is a schematic illustration of a system operable according to embodiments of the invention.

### DETAILED DESCRIPTION OF THE INVENTION

Computer vision based identification of a hand during a process of user-machine interaction has to sometimes deal with diverse backgrounds, some of which may include designs similar to hands.

The method for computer vision based control of a device, according to embodiments of the invention, uses machine learning techniques in a unique way which enables accurate and quick identification of a user's hand.

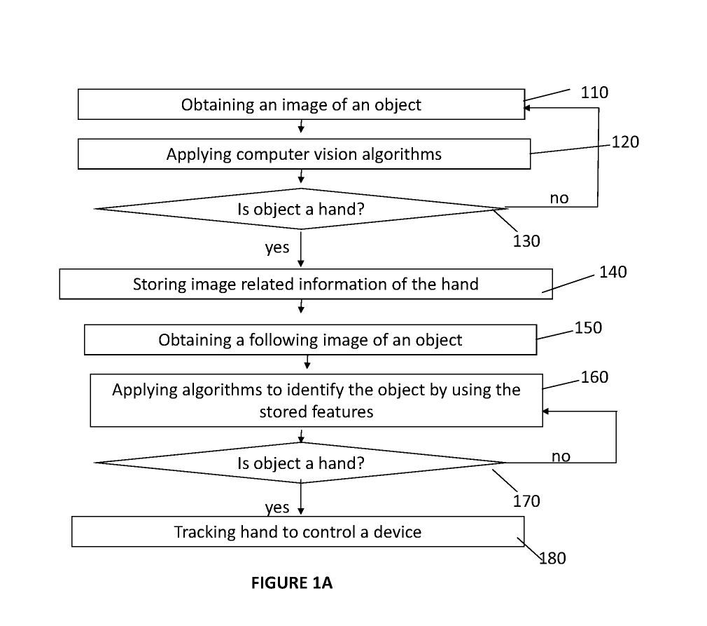

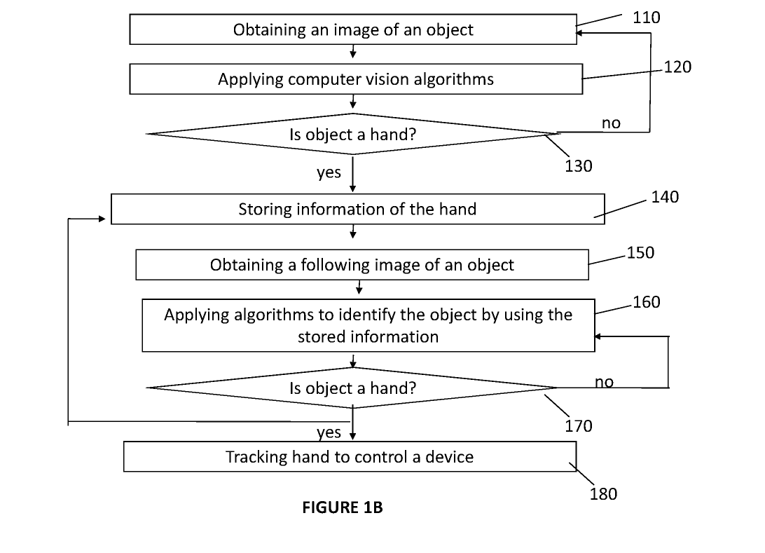

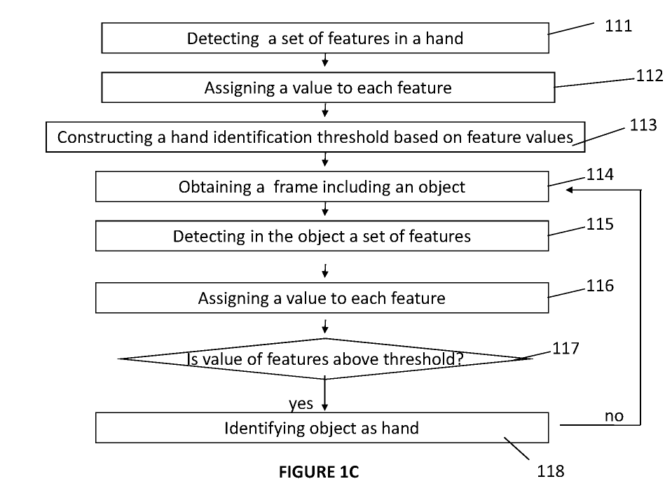

According to one embodiment, which is schematically illustrated in FIG. 1A, the method includes obtaining a first frame, the frame including an image of an object within a field of view (110). In the next step computer vision algorithms are applied to identify the object (120). If the object is identified, by the computer vision algorithms, as a hand (130) then image related information of the identified object (hand) is stored (140). If the object is not identified by the computer vision algorithms as a hand a following image is obtained (110) and checked.

After information of an object identified as a hand is stored (140), the next frame obtained which includes an image of an object within a field of view (150) will be checked for the presence of a hand by applying algorithms which use the stored information (160). If the object in this next frame is identified as a hand by using the stored information (170) then the object is confirmed as a hand and it is further tracked to control the device (180). If the object has not been identified as a hand by using the stored information then a following image is obtained and checked for the presence of a hand by using the stored information (steps 150 and 160).

Tracking of the object may be done also based on the first identification of the object as a hand, in step 130, so that tracking of a hand, which may begin immediately with an initial identification of the hand, may be improved as time goes by. According to some embodiments, if an object is identified as a hand by using computer vision algorithms (step 130) it is tracked but the tracking is terminated if in a following image, which is checked for the presence of a hand by applying algorithms which use the stored information (step 160), it is determined that the object is not a hand. Thus, tracking of the hand identified in the first frame may be continued only if the hand is also identified in the following image.

Computer vision algorithms which are applied to identify an object as a hand in the first frame (in step 120) may include known computer vision algorithms such as appropriate image analysis algorithms. A feature detector or a combination of detectors may be used. For example, a texture detector and edge detector may be used. If both specific texture and specific edges are detected in a set of images then an identification of a hand may be made. One example of an edge detection method includes the Canny™ algorithm available in computer vision libraries such as Intel™ OpenCV. Texture detectors may use known algorithms such as texture detection algorithms provided by Matlab™.

In another example, an object detector is applied together with a contour detector. In some exemplary embodiments, an object detector may use an algorithm for calculating Haar features. Contour detection may be based on edge detection, typically, of edges that meet some criteria, such as minimal length or certain direction.

According to some embodiments an image of a field of view is translated into values. Each pixel of the image is assigned a value that is comprised of 8 bits. According to one embodiment some of the bits (e.g., 4 bits) are assigned values that relate to grey level parameters of the pixel and some of the bits (e.g., 4 bits) relate to the location of the pixel (e.g., on X and Y axes) relative to a reference point within the hand (e.g., the assigned values may represent a distance to a pixel in the center of the hand). The values of the pixels are used to construct vectors (or other representations of the values assigned to pixels) which are used to represent hand objects. A classifier may be used to process these vectors.

Using image related information, such as vectors as described above, provides a more accurate identification of a hand since each pixel is compared to a reference pixel in the hand itself (e.g., to a pixel in the center of the hand) rather than to a reference pixel external to the hand (for example, to a pixel at the edge of the frame).

Other methods of hand identification may include the use of shape detection algorithms together with another parameter such as movement so that an object may be identified as a hand only if it is moving and if it is determined by the shape detection algorithms that the object has a (typically pre-defined) hand shape.

According to one embodiment the object in the first image may be identified using known machine learning techniques, such as supervised learning techniques, in which a set of training examples is presented to the computer. Each example typically includes a pair consisting of an input object and a desired output value. A supervised learning algorithm analyzes the training data and produces an inferred function (classifier), if the output is discrete, or a regression function, if the output is continuous. According to some embodiments training examples may include vectors which are constructed as described above.

The classifier is then used in the identification of future objects. Thus the object in the first image may be identified as a hand by using a pre-constructed database. In this case, a hand is identified in the first frame by using a semi automated process in which a user assists or directs machine construction of a database of hands and in the following frames the hand is identified by using a fully automated process in which the machine construction of a database of hand objects is automatic. An identified hand or information of an identified hand may be added to the first, semi automatically constructed database or a newly identified hand (or information of the hand) may be stored or added to a new fully automatic machine-constructed database.

It should be appreciated that the term “hand” may refer to a hand in any posture, such as a hand open with all fingers extended, a hand open with some fingers extended, a hand with all fingers brought together such that their tips are touching or almost touching, or other postures.

According to one embodiment the “first frame” may include a set of frames. An object in the first frame (set of frames) may be identified as a hand (step 130) by using computer vision algorithms (step 120) but only if it is also determined that the object is moving in a pre-defined pattern. If, for example, an object is identified as having a hand shape (by computer vision algorithms) in five consecutive frames it will still not be identified as a hand unless it is determined that the object is moving, for example, in a specific pattern, e.g., in a repeating back and forth waving motion. According to this embodiment, identification of a hand in a set of frames by using computer vision algorithms will only result in storing information of the object (e.g., adding image related information of the object to a database of hand objects) (step 140) if the object has been determined to be moving and in some embodiment, only if the object has been determined to be moving in a pre-defined, rather than random, movement.

Storing or adding image related information of an object identified as a hand to the database of hand objects (step 140) may be done by applying machine learning techniques, such as by using an adaptive boosting algorithm. Machine learning techniques (such as adaptive boosting) are also typically used in step 160 in which the stored information is used to identify objects in a next frame.

Once an object is identified as a hand according to embodiments of the invention it may be tracked using known tracking methods. Tracking the identified hand (and possibly identifying specific gestures or postures) is then translated into control of a device. For example, a cursor on a display of a computer may be moved on the computer screen and/or icons may be clicked on by tracking a user's hand.

Devices that may be controlled according to embodiments of the invention may include any electronic device that can accept user commands, e.g., TV, DVD player, PC, mobile phone, camera, STB (Set Top Box), streamer, etc.

The method, as schematically illustrated in FIG. 1B, may continue such that once an object is identified as a hand by using the stored information (step 160) information of that object is also stored or added to a database of hand objects. According to some embodiments, once a hand is identified as a hand (in step 130 or 160) information of this hand is compared to information already stored. If the information of an identified hand is very similar to information of a hand already stored (e.g. in a database of hand objects), there may be a decision not to store this additional information so as not to burden the system with redundant information. Thus, storing information of a hand identified in the second frame may be done, in some embodiments, only if the information of the hand identified in the second frame is different than any information already stored.

Image related information may include values or other representations of image features or parameters such as pixels or vectors. Some features, for example, may include Local Binary Pattern (LBP) features, statistical parameters of grey level and/or Speeded Up Robust Features (SURF). Alternatively, image related information may include portions of images or full images.

FIG. 1C schematically exemplifies the use of image related information according to embodiments of the invention.

The method illustrated in FIG. 1C shows one way of how stored information assists and facilitates hand identification in a following image. According to one embodiment, once a hand is identified in a first frame (by computer vision algorithms possibly using known machine learning techniques), a set of features is detected in that hand (111). Features, which are typically image related features, may include, for example, Local Binary Pattern (LBP) features, statistical parameters of grey level and/or Speeded Up Robust Features (SURF). Each detected feature is assigned a value (112). A hand identification threshold is then constructed based on the assigned values (113).

A second frame (which includes an object) is obtained (114). The object is checked for the set of features (115) and each detected feature is assigned a value (116). The values are then calculated and if the calculated values are above the hand identification threshold then the object is identified as a hand (117). If the calculated values do not exceed the hand identification threshold then a following frame is obtained (118) and further checked.

Thus, a hand identification threshold constructed by using values of features of formerly identified hands is used in identification of hands in subsequent images.

The method described in FIGS. 1A-C may be applied, for example, during routine use of a gesture controlled device. A user may wave his hand in front of a gesture controlled system. An image sensor included in the system obtains images of the user's hand and a computer vision algorithm is employed by the system to identify the user's hand. Once the user's hand is identified by the computer vision algorithm, the image of that hand (or image related information of that hand) is stored or added to a database, information which is then used to identify the user's hand in subsequent images. Thus, according to embodiments of the invention, a database of training examples of a hand which are used by learning algorithms is created on-line, while the user is using the system. The advantage of this method, as opposed to using pre-constructed databases of known machine learning techniques, is that the examples in this on-line database are user specific, since it is information of the user's hand itself that is being added to the database each time. A database constructed according to embodiments of the invention includes examples of a user's specific hand and typical background environments of this specific user (machine learning of “background” will be discussed below) so that with each use identifying the hand of the user becomes easier and quicker.

It may be advantageous in some cases to delete stored information or “reset” the database once in a while, for example, so that the database does not become too specific.

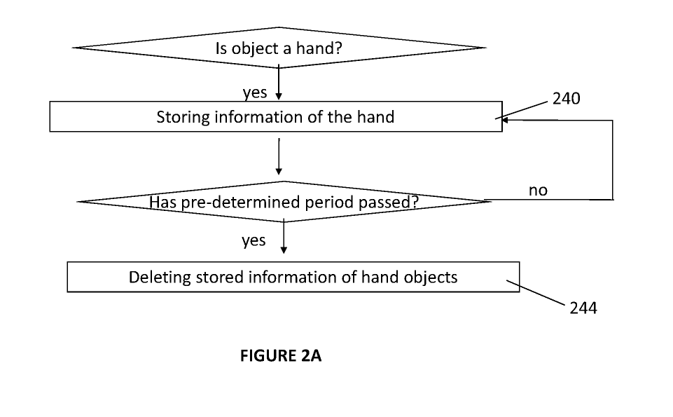

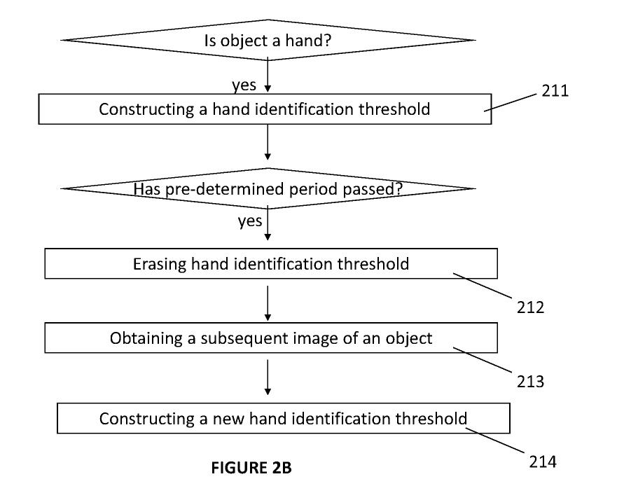

Reference is now made to FIG. 2A, which schematically illustrates a method for re-setting a database of hand objects.

In one embodiment information of an object which has been identified as a hand (for example as described with reference to FIG. 1A) is stored (e.g., added to a database of hand objects) (240). Each information added is stored in the system for a pre-defined period. Once the pre-defined period has passed the information is deleted (244) and the process of machine learning and database construction (for example, as described with reference to FIG. 1A) starts again.

According to some embodiments the pre-defined period is based on use. For example, the database of information of hand objects may be erased after a specific number of sessions. A session may include the time between activation of a program until the program is terminated. According to some embodiments a session includes the time between identification of a hand until the hand is no longer identified (e.g., if the hand exits the frame or field of view). According to one embodiment stored information of hand objects is deleted each time a user ends a session. Thus, according to some embodiments new information is used in each use.

According to other embodiments the pre-defined period is based on absolute time. For example, information may be deleted every day (24 hours) or every week, regardless of its use during that day or week. In some embodiments information may be deleted at a specific time after a session has begun.

According to one embodiment, information may be deleted manually by the user. According to another embodiment information is automatically deleted, for example, after each use (e.g., session).

Similarly, the hand identification threshold (described in FIG. 1C) may be “re-set” once in a while. As schematically illustrated in FIG. 2B, if an object is detected as a hand, a hand identification threshold is constructed (211). After a predetermined period (which may be based on absolute time or on use, such as described with reference to FIG. 2A) the hand identification threshold is erased (212) and in a subsequently obtained frame which includes an object (213) the set of features will be detected in the object and a new hand identification threshold may be constructed (214).

Training a hand identification system according to embodiments of the invention may include presenting to the machine learning algorithm training data which includes both examples of a hand (in different postures) and examples of a “non-hand” object. As opposed to standard machine learning methods, the method according to embodiments of the invention can train an algorithm in a way that is tailored to a user and/or to a specific environment (e.g., specific backgrounds). Thus, according to one embodiment, when applying machine learning techniques to add information of an object identified as a hand to a database of hand objects, information of a non-hand object may at the same time also be stored or added to a non-hand object database.

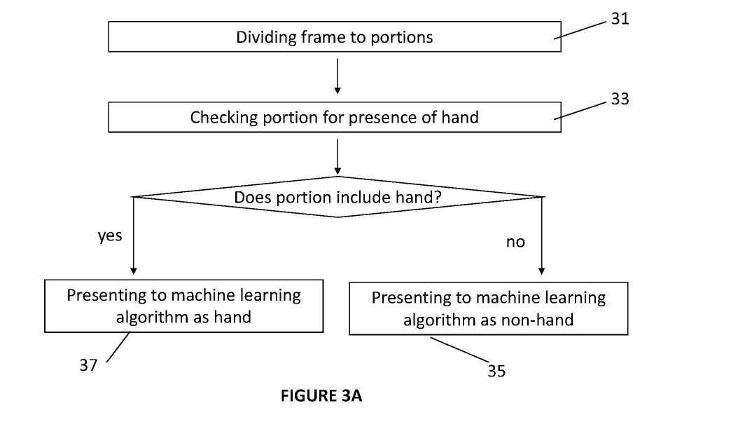

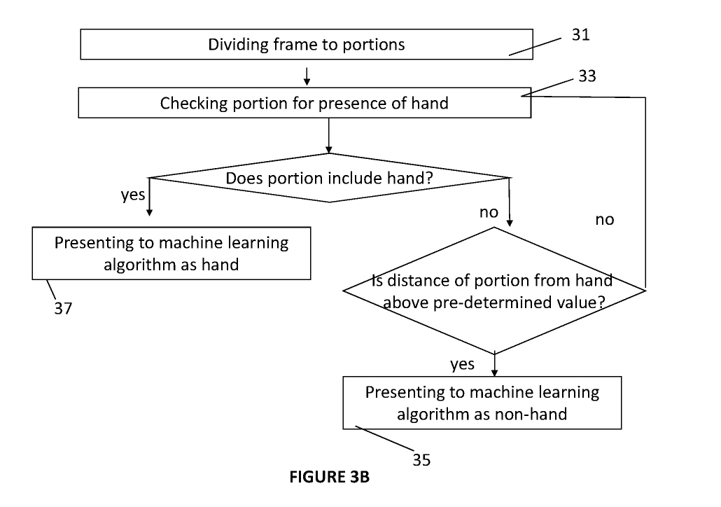

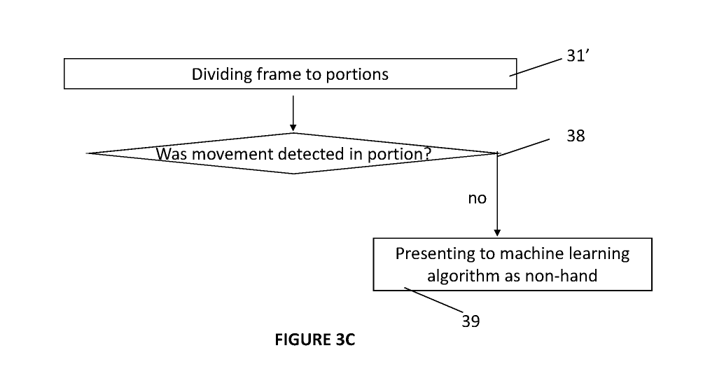

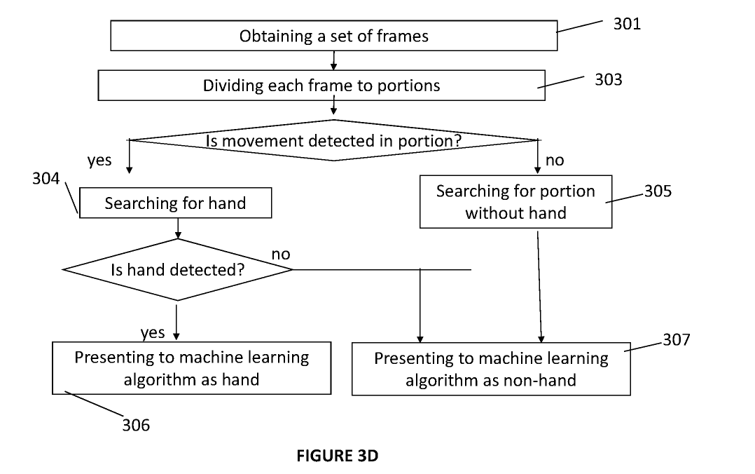

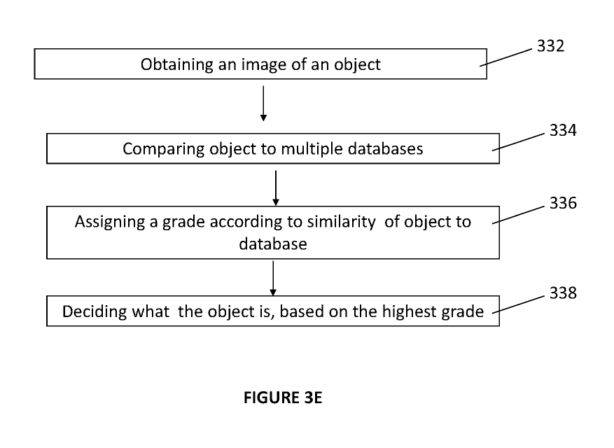

Methods for training a hand identification system according to embodiments of the invention are schematically illustrated in FIGS. 3A-E.

In FIG. 3A a frame or image is divided to portions (31) and each portion is checked for the presence of a hand (33). If the portion does not include a hand then that portion or information of that portion is presented to the machine learning algorithm as a non-hand object (35). According to some embodiments, if the portion does include a hand then that portion or information of that portion of the image is presented to the machine learning algorithm as a hand object (37). Alternatively, only information of the image of the hand (or part of the hand) itself, rather than information of the portion which includes the hand (or part of hand) may be presented to the machine learning algorithm as a “hand information”.

The frame or image that is divided to portions may be the “first frame” (in which an object is identified as a hand by applying computer vision algorithms) and/or the “following frame” (in which an object is identified as a hand by using the information stored on-line).

The frame may be divided to portions based on a pre-determined grid, for example, the frame may be divided into 16 equal portions. Alternatively the frame may be divided to areas having certain characteristics (e.g., areas which include dark or colored features or a specific shape, and areas that do not).

In one embodiment, which is schematically described in FIG. 3B, the frame is divided to portions (31) and the portions are checked for the presence of a hand (33). If a checked portion does not include a hand then the distance of that portion to the portion that does include a hand is determined. If the determined distance is equal to or above a predetermined value (32) then that portion is presented to the machine learning algorithm as a non-hand object (34). According to this embodiment, only portions of an image which are far from the portion including the hand are defined as “non-hand”.

According to another embodiment a set of frames is checked for the presence of a hand in each of the frames. The set of frames is also checked for movement. Movement may indicate the presence of a hand, for example, in cases where a user is expected to move his hand as a means for activating and/or controlling a program.

According to one embodiment a portion (or information of that portion) is presented as a non-hand object only if it is at a distance that is equal to or above the predetermined value and if no movement was detected in that portion.

According to one embodiment, which is schematically described in FIG. 3C, a set of frames is checked. Each of the frames in the set of frames is divided to portions (31′) and each portion is checked to see if movement was detected in that portion (38). If no movement was detected in the area of the checked portion then that portion (or information of that portion) is presented to the machine learning algorithm as a non hand object (39). In some embodiments, a determination must be made that no hand and no movement were detected in a portion in order for that portion (or information of that portion) to be presented to the machine learning algorithm as a non-hand object.

These embodiments may raise the accuracy of identification of non-hand objects, thus lowering the false positive reading rate of the system.

According to one embodiment, which is schematically described in FIG. 3D, a set of frames is obtained (301) and each frame is divided to portions (303). Movement is searched for in the set of frames. If movement is detected in a certain portion then that portion is searched for the presence of a hand (304). If a hand is detected then information of the identified hand (or the portion which includes the hand) is presented to the machine learning algorithm as a hand object (306) and may be stored or added to the database of hand objects.

If movement is not detected in the set of frames then each frame in the set of frames is searched for portions that do not include a hand (305). Portions detected which do not include a hand may then be presented to the machine learning algorithm as a non-hand object (307).

This embodiment may lower the rate of false positive identifications of the system and may reduce computation time by applying algorithms to identify a hand only in cases where movement was detected (thus indicating possible presence of a hand).

In general, the method of hand identification using on-line machine learning, according to embodiments of the invention, takes up less computing time than known (“off-line”) machine learning techniques because only limited data (user specific scenes) needs to be learnt on-line, compared with the many examples presented to a machine learning algorithm off-line.

According to one embodiment a hand searched in the methods described above may be a hand in a specific posture, for example, a posture in which a hand has all fingers brought together such that their tips are touching or almost touching. If such a posture of a hand is detected in an image, by computer vision methods, information of this image or of a portion of this image is stored, for example, in a first posture hand database. If a second, different posture is detected, in a second image, by computer vision methods, information of the second image, or of a portion of the second image is stored, for example, in a second posture hand database. Thus, several databases may be concurrently constructed on-line, according to embodiments of the invention.

According to one embodiment a database may include a post-posturing hand. For example, one database may include hand objects (or information of hand objects) in which the hand is closed in a first or a hand that has all fingers brought together such that their tips are touching or almost touching. Another database may include hands which are opening; extending fingers after having held them in a first or closed fingers posture. The present inventor has found that “post posture” hands are specific to users (namely, each user moves his hand between hand postures in a unique way). Thus, using a “post-posture” database may add to the specificity and thus to the efficiency of methods according to the invention.

A method according to one embodiment, which is schematically illustrated in FIG. 3E, includes obtaining an image of an object within a field of view (332). The object is compared to a plurality of databases (334) and a grade is assigned (336) according to the similarity of the object to the database in each case. A decision is made regarding the object (e.g., whether it is a hand in a specific posture, whether it is a hand in “post-posture”, whether it is a “non-hand” object, etc.) based on the highest grade (338).

According to one embodiment a “wild card” database can be created and used in a case where two grades are too similar to enable a decision. The wild card database is typically made up of information of the previous frame, the frame before the one being checked at present.

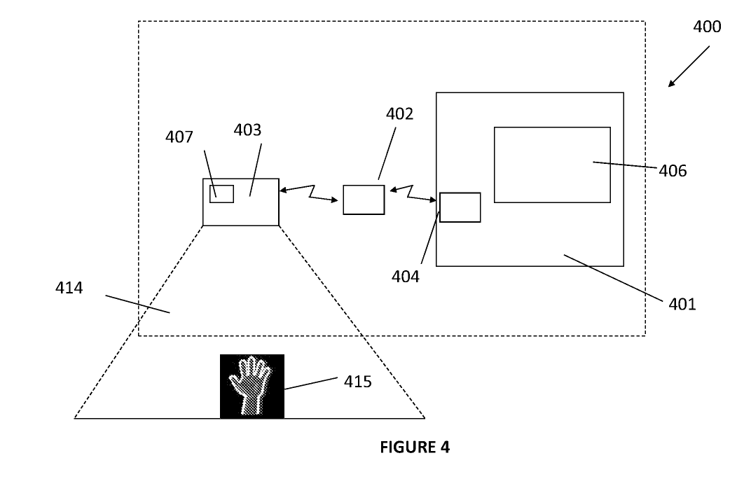

Reference is now made to FIG. 4 which schematically illustrates system 400 according to an embodiment of the invention.

System 400 includes an image sensor 403 for obtaining a sequence of images of a field of view (FOV) 414, which may include an object (such as a hand 415). The image sensor 403 is typically associated with processor 402, and storage device 407 for storing image data. The storage device 407 may be integrated within the image sensor 403 or may be external to the image sensor 403. According to some embodiments image data may be stored in processor 402, for example in a cache memory.

The processor 402 is in communication with a controller 404 which is in communication with a device 401. Image data of the field of view is sent to processor 402 for analysis. A user command is generated by processor 402, based on the image analysis, and is sent to a controller 404 for controlling device 401. Alternatively, a user command may be generated by controller 404 based on data from processor 402.

The device 401 may be any electronic device that can accept user commands from controller 404, e.g., TV, DVD player, PC, mobile phone, camera, STB (Set Top Box), streamer, etc. According to one embodiment, device 401 is an electronic device available with an integrated standard 2D camera. According to other embodiments a camera is an external accessory to the device. According to some embodiments more than one 2D camera are provided to enable obtaining 3D information. According to some embodiments the system includes a 3D camera.

The processor 402 may be integrated within the device 401. According to other embodiments a first processor may be integrated within the image sensor 403 and a second processor may be integrated within the device 401.

The communication between the image sensor 403 and processor 402 and/or between the processor 402 and controller 404 and/or device 401 may be through a wired or wireless link, such as through IR communication, radio transmission, Bluetooth technology and/or other suitable communication routes.

According to one embodiment image sensor 403 is a forward facing camera. Image sensor 403 may be a standard 2D camera such as a webcam or other standard video capture device, typically installed on PCs or other electronic devices. According to some embodiments, image sensor 403 can be IR sensitive.

The processor 402 can apply computer vision algorithms, such as motion detection and shape recognition algorithms to identify and further track an object, typically, the user's hand. The processor 402 or another associated processor may comprise an adaptive detector which can identify an object in a first image as a hand and can add the identified hand to a database of hand objects. The detector can then identify an object in a second image as a hand by using the database of hand objects (for example, by implementing methods described above).

Once the object is identified as a hand it is tracked by processor 402 or by a different dedicated processor. The controller 404 may generate a user command based on identification of a movement of the user's hand in a specific pattern based on the tracking of the hand. A specific pattern of movement may be for example, a repetitive movement of the hand (e.g., wave like movement).

Optionally, system 400 may include an electronic display 406. According to embodiments of the invention, mouse emulation and/or control of a cursor on a display, are based on computer visual identification and tracking of a user's hand, for example, as detailed above. Additionally, display 406 may be used to indicate to the user the position of the user's hand within the field of view.

System 400 may be operable according to methods, some embodiments of which were described above.

According to some embodiments systems distributed to users may be later used to construct a new, more accurate database of hand objects by obtaining data from the users and combining the databases of all the different users' systems to create a new database of hand (and/or non-hand) objects.

1. A method for computer vision based control of a device, the method comprising:
obtaining a first frame comprising an image of an object within a field of view;
identifying the object as a hand by applying computer vision algorithms;
storing image related shape information of the identified hand;
obtaining a second frame comprising an image of a hand within a field of view and identifying the shape of the hand in the second frame as a hand by using the stored shape information of the identified hand; and
controlling the device based on the shape of the hand identified in the first and second frames.

2. The method according to claim 1 comprising tracking the hand identified in the first frame and continuing the tracking only if the hand is also identified in the second image.

3. The method of claim 2 comprising controlling the device according to the tracking of the hand.

4. The method according to claim 1 comprising storing image related shape information of the hand identified in the second frame.

5. The method according to claim 1 comprising identifying a non-hand object and storing image related information of the non-hand object.

6. The method according to claim 5 comprising storing the image related shape information of the object identified as a hand and the image related information of the non-hand object, only if the information is different than any image related information already stored.

7. The method according to claim 1 comprising storing image related shape information of an object identified as a hand for a first pre-defined period.

8. The method according to claim 7 wherein the first pre-defined period is based on use.

9. The method according to claim 7 wherein the first pre-defined period is based on absolute time.

10. The method according to claim 5 comprising storing image related information of the non-hand object for a second pre-defined period.

11. The method according to claim 10 wherein the second pre-defined period is based on use.

12. The method according to claim 10 wherein the second pre-defined period is based on absolute time.

13. The method according to claim 5 wherein the non-hand object comprises a portion of a frame, said portion not including a hand.

14. The method according to claim 13 wherein the portion is located at a pre-determined distance or further from the position of the hand within the frame.

15. The method according to claim 13 wherein the portion includes an area in which no movement was detected.

16. The method according to claim 1 wherein the image related shape information comprises features selected from the group consisting of Local Binary Pattern (LBP) features, statistical parameters of grey level and Speeded Up Robust Features (SURF).

17. The method according to claim 1 wherein identifying the object in the second frame as a hand by using the shape information of the identified hand comprises:
detecting in the identified hand a set of features;
assigning a value to each feature; and
comparing the values of the features to a hand identification threshold, said hand identification threshold constructed by using values of features of formerly identified hands.

18. The method according to claim 17 comprising constructing a new hand identification threshold at predetermined intervals.

19. The method according to claim 1 comprising identifying the object in the first image as a hand only if the object is moving in a pre-defined movement.

20-29. (canceled)
